(19) United States
(12) Patent Application Publication
(10) Pub. No.: US 2024/0071638 A1
(43) Pub. Date: Feb. 29, 2024

(54) RADIATION SHIELDING COMPOSITE MATERIAL

(71) Applicants: John Eric Chapman, Gray, TN (US); Oleksandr Biland, Houston, TX (US); Volodymyr Gulik, Kiev (UA)

(72) Inventors: John Eric Chapman, Gray, TN (US); Oleksandr Biland, Houston, TX (US); Volodymyr Gulik, Kiev (UA)

(21) Appl. No.: 18/272,134

(22) PCT Filed: Jan. 11, 2022
(86) PCT No.: PCT/US22/11981

§ 371 Date: Jul. 13, 2023

Related U.S. Application Data
(60) Provisional application No. 63/220,577, filed on Jul. 12, 2021.
(60) Provisional application No. 63/136,793, filed on Jan. 13, 2021.

(51) Int. Cl. G21F 1/04; C04B 14/46; C04B 28/02

(52) U.S. Cl. CPC G21F 1/042; C04B 14/4668; C04B 28/023; C04B 2111/00258

(57) ABSTRACT

Radiation shielding composite material can include basalt fiber and concrete. The basalt fiber can be basalt-boron fiber, basalt-gadolinium fiber, basalt-boron gadolinium fiber, or a combination thereof. The concentration can be up to about 60 kilograms per cubic meter and, in some embodiments, range from about 60 kilograms per cubic meter to about 20 kilograms per cubic meter. The basalt fiber can be formed from a basalt melt that includes up to about 20% of boron oxide, up to about 20% of gadolinium oxide, and up to about 10% of boron oxide and about 10% of gadolinium oxide. The concrete can be ordinary concrete or heavy (i.e., barite) concrete.

### CROSS REFERENCE TO RELATED APPLICATION

This application claims the benefit under 35 U.S.C. § 119(e) of co-pending U.S. Provisional Application No. 63/220,577 entitled “RADIATION SHIELDING COMPOSITE MATERIAL” filed Jul. 12, 2021, and U.S. Provisional Application No. 63/136,793 entitled “RADIATION SHIELDING COMPOSITE MATERIAL” filed Jan. 13, 2021, both of which are incorporated herein by reference.

### TECHNICAL FIELD

The subject disclosure is directed to new and improved radiation shielding and, in particular, radiation shielding composite material that includes fibers that contain radiation absorption materials embedded in volcanic (igneous) rock.

### BACKGROUND ART

Neutron radiation can be generated as a result of a variety of nuclear reactions or interactions. One source of neutron radiation is from the nuclear reactor itself. Another source of neutron radiation is nuclear waste, so that the processing and the disposal of such waste creates additional challenges. Either types of sources require nuclear radiation shielding and nuclear radiation shielding materials.

One technique for processing and for disposing nuclear waste involves vitrification and immobilization of the nuclear material. The glasses produced in such processes have good radiation absorption properties. However, such processes produce materials that have poor mechanical properties, such as a low yield strength. Such materials are unsuitable for products that can be used as structural members, either alone or as a reinforcing component of a composite material.

It is of vital importance, therefore, to provide adequate shielding from any sources of neutron radiation. Furthermore, it is desirable to provide shielding through the use of structural materials that have desirable mechanical properties. Various methods and devices are known to be capable of providing shielding from such radiation, but do not have adequate mechanical strength.

Many neutron radiation shielding materials utilize reinforced concrete. Concrete is a composite material that includes aggregates that are bound together with cement-water mixture. The aggregates can include fine and coarse aggregate that are bonded together with a fluid cement (cement paste) that hardens (cures) over time.

Concrete is primarily used for construction and stands as one of the most common and durable building materials. Durability becomes increasingly important for applications in nuclear energy area.

It is known that varying chemical composition of concrete also affects the shielding properties. There are several types of basic radiation shielding concretes, such as serpentine, serpentine-iron, limonite, limonite-magnetite, magnetite, magnetite-serpentine, hematite, ilmenite, ferrophosphorus and barite concrete.

For example, it is known that elemental boron has beneficial properties when used as a component of shielding devices. Materials having the highest density of boron are very desirable in order to maximize the effectiveness of the shielding. As a result, shielding arrangements such as dry-packed boron carbide in metal boxes, boron-loaded polyethylene plastic sheets, and boron-loaded drywall have been disclosed in the art.

When such shielding takes the form of concrete, it can be incorporated into the structure of a building or any portion thereof. In such a case, the concrete must be of sufficient strength to satisfy the structural requirements of the building elements.

One known concrete radiation shield system utilizes a concrete mix that incorporates boron which can be used as a thermal neutron shield. Boron, in the form of boron carbide of varying grit sizes, can be added to the concrete mixture in place of the traditionally found ingredients of sand and aggregate. In such systems, the total boron carbide content of the mixture can include 80% coarse boron carbide particles and 15% fine boron carbide particles. The resulting boron content of the finished concrete exceeds that of dry-packed boron carbide powder.

Another type of radiation shield system utilizes a material infused with boron oxide continuous basalt fibers and, in particular, concrete reinforcement members that include such fibers. Such materials exhibit improved neutron shielding of concrete for nuclear facilities that produce radiation in a fast fission spectrum (e.g. with reactors as BN-800, FBTR) and thermal neutron spectrum (Light Water Reactors (LWR)). Such materials can decrease the thickness of radiation shielding material in thermal spectrum reactors, but do not have the desired mechanical properties.

Unfortunately, none of the foregoing technologies or systems are able to achieve a high boron density with the requisite mechanical strength. Further, all such technologies are traditionally quite expensive to deploy. It is therefore preferable to have a cost-effective method of shielding that is able to take advantage of the characteristics of the known neutron shielding materials, so as to provide an adequate amount of shielding from thermal neutrons.

Additionally, the above-described systems are undesirable because of the associated expenses, mechanical properties, and, with respect to the above-described reinforced concrete systems, low flexural strength, which is particularly problematic in seismic zones. Accordingly, there is a need for an improved composite system that can decrease the probability and ratio of crack formations in a more efficient manner.

### DISCLOSURE OF INVENTION

In various implementations, a radiation shielding material or composition of matter includes basalt fiber and concrete. The basalt fiber can be basalt-boron fiber, basalt-gadolinium fiber, basalt-boron gadolinium fiber, or a combination thereof. The concentration of fiber can be up to about 100 kilograms per cubic meter and, in some embodiments, range from about 100 kilograms per cubic meter to about 20 kilograms per cubic meter.

### BRIEF DESCRIPTION OF THE DRAWINGS

FIG. 1 is a schematic diagram of an exemplary process in accordance with this disclosure.

FIG. 2 is another schematic diagram of an exemplary process in accordance with this disclosure.

FIG. 3 is a block diagram of an exemplary process in accordance with this disclosure.

### MODES FOR CARRYING OUT THE INVENTION

The subject disclosure is directed to new and improved radiation shielding and, in particular, radiation shielding composite material that includes fibers that contain radiation absorption materials embedded in volcanic (igneous) rock. The radiation shielding material or composition of matter can include basalt fiber and concrete. The basalt fiber can be basalt-boron fiber, basalt-gadolinium fiber, basalt-boron gadolinium fiber, or a combination thereof. The concentration of fiber can be up to about 100 kilograms per cubic meter and, in some embodiments, range from about 100 kilograms per cubic meter to about 20 kilograms per cubic meter.

In other embodiments, the concentration of fiber can be up to about 60 kilograms per cubic meter. In yet other embodiments, the concentration of fiber can range from about 60 kilograms per cubic meter to about 20 kilograms per cubic meter.

The basalt fiber can be formed from a basalt melt that includes up to about 20% of boron oxide, up to about 20% of gadolinium oxide, and up to about 10% of boron oxide and about 10% of gadolinium oxide. The concrete can be ordinary concrete or heavy (i.e., barite) concrete. In some embodiments, the concrete can include heavier elements with higher atomic numbers to increase shielding from gamma radiation.

In other implementations, a radiation shielding composite material is provided. The radiation shielding composite material can include fibers that contain radiation absorption materials embedded in volcanic (igneous) rock. An exemplary chemical composition of the fiber can include: between about 45% and about 68% SiO₂; between about 14% and about 23% Al₂O₃; up to about 15% metal oxides (i.e., MgO+ CaO); up to about 18% iron oxides (i.e. FeO+Fe₂O₃); up to about 12% (i.e., K₂O+Na₂O); between about 0.5% and 3% TiO; up to about 30% Gd, B, Hf, Sm, Eu, or other heavy metals having high neutron absorption cross sections, alone or in combination thereof; and between up to about 2% rest and trace elements. The matrix can include concrete or other similar materials.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The operation of dry nuclear fuel storage facilities (SNF) can depend upon the reduction of the level of radioactive radiation at the SNF storage facility. The main source of radioactive radiation at the SNF can emit neutrons and gamma quanta. As a result, specialized containers, such as HI STORM 190 UA, must be used to store nuclear materials.

HI STORM 190 UA containers utilize so-called biological protection concrete to protect against the emission of gamma radiation. Such containers include heavy materials that absorb gamma radiation. Such containers also include METAMIC™ material to protect against neutron radiation. METAMIC™ is a trademark of Holtec International of Jupiter, Florida.

The disclosure is directed to a radiation shielding composite material that can replace the combination biological protection concrete and METAMIC™ material. The disclosed material provides concrete shield that has increased radiation shielding and improved structural (flexural) strength. The material provides increased resistance to cracking, which is the main reason for degradation in nuclear power plants. Such materials can be used in specialty structural members for concrete reinforcement, which substantially decreases the probability and the ratio of crack formation. The materials exhibit high radiation shielding, high strength, improved distribution in volume, improved thermal expansion properties, and other improved properties.

The radiation shielding composite material can be produced through the reinforcement of concrete with radiation absorbing materials. The material includes a concrete mix that contains volcanic rock fiber of various shapes, such as chopped fibers, milled fibers, coarse fibers (i.e., fibers that are similar in shape to steel fibers), and other similar materials. The fibers can be infused with, or alloyed by, neutron-absorbing materials, such as cadmium, hafnium, gadolinium, boron, cobalt, samarium, titanium, dysprosium, erbium, europium or ytterbium.

Concrete materials that include the concrete mix provide enhanced radiation shielding properties and enhanced structural strength, as compared to conventional reinforced concrete materials. The radiation shielding composite material provides the observed enhanced shielding properties without compromising the structural strength of conventional concrete.

Other embodiments include similar concrete matrices reinforced with composite structural members, such as rebars, mesh, and other similar members, made of volcanic rock fibers infused with, or alloyed by, radiation absorbing materials.

The radiation shielding composite material can include fibers that contain radiation absorption materials embedded in volcanic (igneous) rock. An exemplary chemical composition of the fiber can include: between about 45% and about 68% SiO₂; between about 14% and about 23% Al₂O₃; up to about 15% metal oxides (i.e., MgO+CaO); up to about 18% iron oxides (i.e. FeO+Fe₂O₃); up to about 12% (i.e., K₂O+Na₂O); between about 0.5% and 3% TiO; up to about 30% Gd, B, Hf, Sm, Eu, or other heavy metals having high neutron absorption cross sections, alone or in combination thereof; and between up to about 2% rest and trace elements. In some embodiments, the heavy metals should be heavy metals with larger neutron absorption cross sections is larger.

The relatively high ratio of iron oxides (FeO+Fe₂O₃) in such fibers provides for the use of minimized iron content additives, such as steel shot, metal scrap, and other similar materials, in heavy concrete composites.

The fibers structure is amorphous. In some embodiments, the fiber filament diameter ranges from about 7 microns to about 25 microns. In such embodiments, the fiber length is continuous to allow the fibers to be used as construction structural materials, such as rebars, meshes, chopped fibers and coarse fibers.

Basalt boron fibers represent a new additive to concrete that can reduce neutron radiation. Basalt-boron fiber is a short fiber added to concrete at the stage of preparation of a dry mixture. Basalt-boron fiber can be obtained when boron basalt glass of is added to the melt in the amount of about 5% to about 20%. In such materials, boron oxide is used as a neutron-absorbing material, which is cheaper than boron carbide.

Further, fibers produced with boron oxide can improve the mechanical characteristics of concrete. Such fibers produce composite materials that have increased durability and resistance to cracking. Additionally, such fibers provide a substantially uniform distribution of boron cores in a particular volume of concrete, which reduces the mass of the neutron-absorbing material in the concrete matrix.

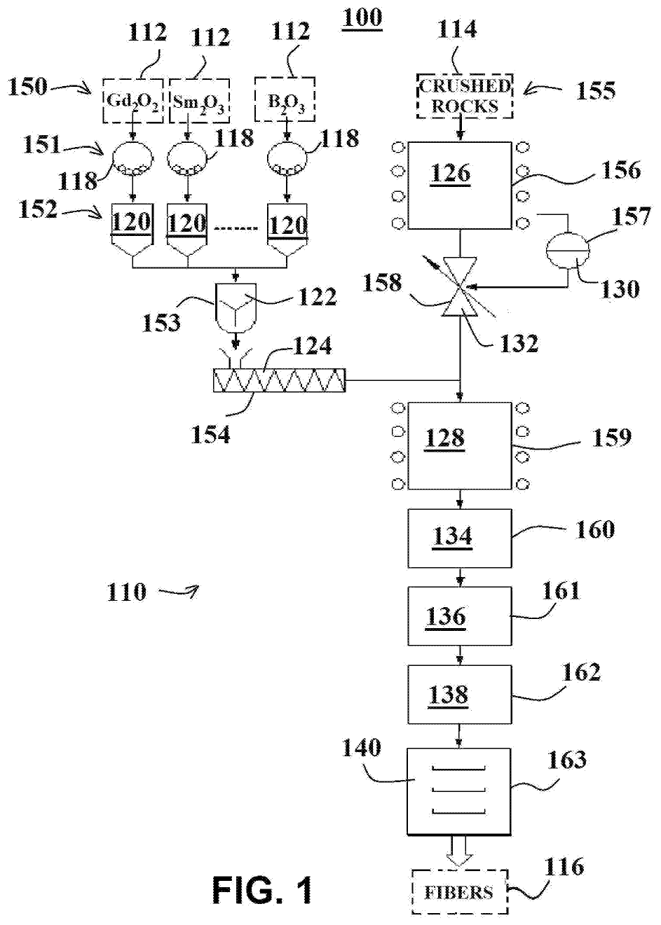

Referring to FIG. 1, a method 100 for manufacturing increased radiation resistance continuous fibers is shown. The fibers can be used to produce the radiation shielding composite material that provides concrete shield that has increased radiation shielding and improved structural (flexural) strength that is described in accordance with this subject matter. The method 100 is a batch process that can be synchronized by time and volume.

The method 100 is performed using an exemplary system, generally designated by the numeral 110, to convert radiation absorbing elemental compounds 112 and crushed rocks 114 into fibers 116. The system 110 includes milling devices 118, hoppers 120, metered mixing devices 122, a charger 124, a pair of cold crucible induction melters or furnaces 126-128, a meter 130, a valve 132, a melt conditioning channel 134, a fiber forming device 136, a sizing applicator and winding apparatus 138, and a dryer 140.

At 150, the radiation absorbing elemental compounds 112 are provided. The radiation absorbing elemental compounds can include Gd₂O₃, B₂O₃, Sm₂O₃, Hf₂O₃ and other similar materials. In this exemplary embodiment, the radiation adsorbing elemental compounds 112 can include elements, such as one or more of Gd, B, Hf, Sm, Eu, or other similar elements.

At 151, the radiation absorbing elemental compounds 112 are loaded into the milling devices 118. In this exemplary embodiment, this step is optional. When Step 151 is included in the method 100, the radiation absorbing elemental compounds 112 are milled into particles of fraction having a grit of not less than about grit 80.

At 152, the radiation absorbing elemental compounds 112 are loaded into hoppers 120. When Step 151 is not omitted, the radiation absorbing elemental compounds 112 are milled before being loaded into the hoppers 120.

At 153, the radiation absorbing elemental compounds 112 are mixed with metered mixing devices 122. In some embodiments, the mixture of radiation absorbing compounds 112 can include just one radiation absorbing elemental compound, multiple lines of compounds, or combinations thereof, so that the mixture provides predetermined properties. The resulted fractioned elements can be thoroughly weighed and mixed with the metering mixing devices 122 in this step.

At 154, the mixture of radiation absorbing elemental compounds 112 is provided to a charger 124.

At 155, crushed rocks 114 are provided. The crushed rocks 114 include volcanic rocks that have been crushed, washed, and dried. In this exemplary embodiment, the crushed rocks 114 are volcanic rocks with specific chemical compositions. In such embodiments, the quantity of iron oxides is not lower than about 8%. The crushed rocks 114 can include basalt, gabbro, basaltic andesite or andesite nature rocks that are rich with plagioclases and pyroxenes.

At 156, the crushed rocks 114 are loaded into the cold crucible induction melter 126. In this exemplary embodiment, the cold crucible induction melter 126 operates at a range of operating temperatures of between about 1500° C. and about 2500° C. The time of the melting within the cold crucible induction melter 126 should be sufficient to reach a rich liquidus point. In some embodiments, the period of time in which the crushed rocks 114 can be melted in the cold crucible induction melter 126 can range from between about 15 minutes to about 60 minutes. The melt should be stirred in this step through the adjustment of induction frequency and power.

At 157, the amount of melting is monitored with a meter 130. The meter 130 can be a melt level meter.

At 158, a valve 132 is operated to control the flow of material from the cold crucible induction melter 126 to be combined with the radiation absorbing elemental compounds 112 for flow into the cold crucible induction melter 128. In this step a portion of the melt, which can include between about 50% and about 70% of the material, is dumped through the valve 132 to the cold crucible induction melter 128. The volume of the dumped melt can be controlled by the meter 130 of Step 157.

The next batch of rocks for melting can be loaded into the cold crucible induction melter 126 at Step 156 only after the valve 132 is closed and between about 50% and about 70% of the previous melt is dumped.

At 159, the mixture from Step 154 and the mixture from the cold crucible induction melter 126 in Step 156 in the cold crucible induction melter 128. The mixture of radiation absorbing elemental compounds 112 always goes on the top of the molten crushed rocks 114 in the cold crucible induction melter 128.

The cold crucible induction melter 128 operates at an operating temperature within the range of about 1500° C. and about 3000° C. In some embodiments, the mixture can be heated a period of time of between about 15 minutes and 60 minutes. The melt should be stirred in this step through the adjustment of induction frequency and power for the cold crucible induction melter 128.

At 160, the molten material produced in Step 159 by the cold crucible induction melter 128 flows through the melt conditioning channel 134.

At 161, the molten material produced from Step 159 by the cold crucible induction melter 128 for processing through the melt conditioning channel 134 in Step 160 flows into the fiber forming device 136 to produce unfinished fibers. In this exemplary embodiment, the fiber forming device 136 operates at an operating temperature within the range of about 1300° C. and about 1600° C.

The fiber forming device 136 includes tiny bushings through which the molten mixture pulled out by gravity to the sizing applicator and winding apparatus 138 to form the continuous fibers 116. Between a bushing and a winder, the fibers 116 are cooled, gathered and sized.

In this exemplary embodiment, no stirring of the melt shall occur in the fiber forming chamber, so that the flow is strictly laminar inside the fiber forming device 136. This should occur regardless of which fiber forming method is utilized to form the fibers 116.

At 162, the fibers 116 are processed with a sizing applicator and winding apparatus 138 to produce sized, wound fibers 116.

At 163, the sized, wounds fibers 116 from Step 162 are dried in a dryer 140. Wound cakes of the fibers 116 can be dried and sent for further conversion to chopped fibers, mesh, rebars and coarse fibers.

The fibers 116 produced through the method 100 can be used to make various composite materials in various configurations and complicated shapes that form radiation shielding composite materials.

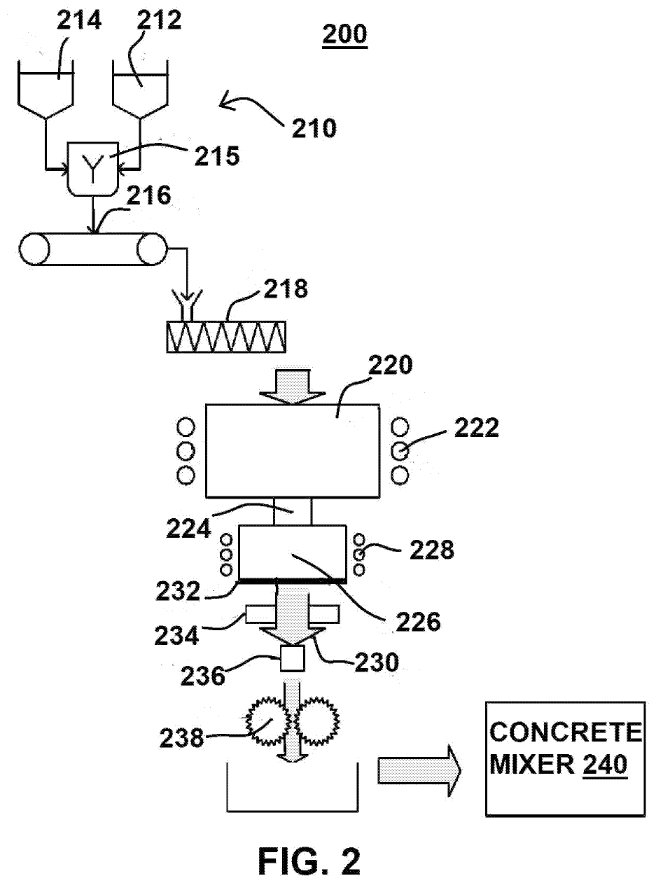

Referring to FIG. 2 with continuing reference to the foregoing figure, another exemplary process, generally designated with the numeral 200, is shown. In this exemplary process, metering and mixing equipment 210 is used to mix basalt 212 with radiation absorbing compounds 214, such as boron compounds and, in some instances gadolinium compounds, to form a mixture. The mixing equipment 210 includes a weight-mixing device 215.

The mixture is conveyed, using conveyors or conveying equipment 216, to a batch charger 218. The mixture is fed into a melting chamber 220, which is heated by an induction coil 222. The melting chamber 220 is in fluid communication with a conditioning chamber 224. The conditioning chamber 224 feeds into a fiber-forming chamber 226, which is heated by an induction coil 228.

The fiber forming chamber 224 forms fiber strands 230 by pushing the melted mixture through a fiber plate. The fiber strands 230 passes through a sizing applicator 234. From the sizing applicator 234, the fiber strands 230 are further processed with a gathering shoe 236 and a direct chopper 238. Then, the fiber strands 230 are transferred to a concrete mixer 240 to form radiation shielding composite materials.

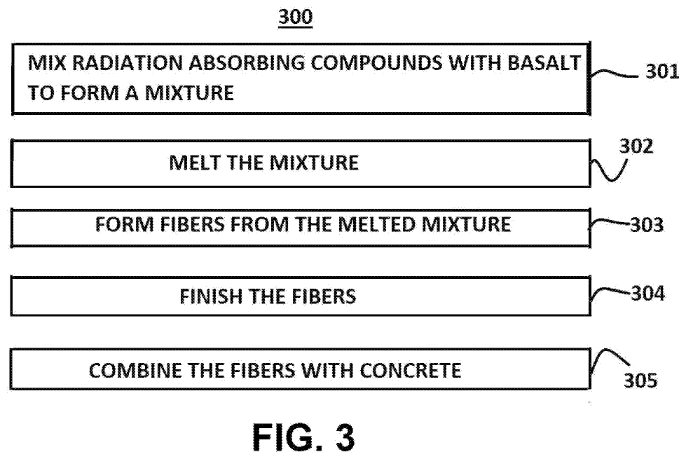

Referring to FIG. 3 with continuing reference to the foregoing figure, an exemplary method 300 for forming a radiation shielding composite material or similar composition of matter is shown. The method 300 can use the fibers that are produced through the process shown in FIG. 1 and can produce the composite materials in a similar manner, as is shown in FIG. 2.

At 301, radiation absorbing compounds are mixed with basalt to form a mixture. The radiation absorbing compounds can include borates, boron compounds, and gadolinium compounds.

At 302, the mixture is melted. In this exemplary embodiment, the mixture is melted in a melting chamber that is heated through induction.

At 303, fibers are formed from the melted mixture. The fibers can be drawn through a plate. The fibers can be conditioned before being drawn.

At 304, the fibers are finished. The fibers can be finished through various finishing operations, such as sizing, gathering, and chopping.

At 305, the fibers are combined with a matrix material, such as concrete to form radiation shielding material.

### Examples 1-5

In Example 1, a radiation shielding composite material is formed with fibers that contain radiation absorption materials embedded in volcanic (igneous) rock. The matrix is concrete. In Examples 2-5, the radiation shielding composite materials can include rock fibers, rock fiber composites, burnable absorbers, and non-burnable absorbers.

### Example 6

In Example 6, a radiation shielding composite material is formed from a fiber formed through the method 100 shown in FIG. 1. The matrix is Portland cement.

### Example 7

In Example 7, a radiation shielding composite material is formed from a fiber formed through the method 100 shown in FIG. 1. The matrix is geopolymer.

### Examples 8-10

In Examples 8-10, three types of basalt fibers were produced. In Example 8, the basalt melt that produced the basalt fiber was formed with 20% boron oxide. In Example 9, the basalt melt that produced the basalt fiber was formed with 20% gadolinium oxide. In Example 10, the basalt melt that produced the basalt fiber was formed with 10% boron oxide and 10% gadolinium oxide. All three types of modified basalt fiber successfully increase the protective characteristics of HI STORM 190 UA containers from neutron radiation, especially for thermal and epithet plus neutrons.

### Examples 11-28

In Examples 11-28, the fibers from Examples 8-10 were mixed with ordinary concrete and heavy (i.e., barite) concrete to form radiation shielding composite materials. The fibers were mixed with the concrete, so that the fibers had concentrations of 20 kilograms per cubic meter, 40 kilograms per cubic meter and 60 kilograms per cubic meter.

The composite materials produced in Examples 11-28 significantly reduced the flow of neutrons through the materials. The effect was observed in the composite materials that had a concentration of fibers ranging from about 20 kilograms per cubic meter to 60 kilograms per cubic meter. The composite materials made with the fibers produced in Example 10 showed the most significant improvement in neutron flow reduction.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible. The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

1-20. (canceled)

21. A method for forming a radiation shielding composite material comprising:
mixing radiation absorbing compounds with basalt to form a mixture with the radiation absorbing compounds being selected from the group consisting of borates, boron compounds, and gadolinium compounds;
melting the mixture in a melting chamber through induction heating to produce a melted mixture;
forming the melted mixture into basalt fibers;
finishing the basalt fibers; and
combining the basalt fibers with a matrix material to form radiation shielding material.

22. The method of claim 22, wherein the forming step forms basalt fibers selected from the group consisting of basalt-boron fibers, basalt-gadolinium fibers, and basalt-boron gadolinium fibers.

23. The method of claim 21, wherein the matrix material is selected from the group consisting of Portland cement, barite concrete, and geopolymers.

24. The method of claim 21, wherein the combining step includes:
combining the basalt fibers with the matrix material to form radiation shielding material having a concentration of basalt fiber of up to about 60 kilograms per cubic meter.

25. The method of claim 21, wherein the combining step includes:
combining the basalt fibers with the matrix material to form radiation shielding material having a concentration of basalt fiber of between about 60 kilograms per cubic meter and about 20 kilograms per cubic meter.

26. The method of claim 21, wherein the melted mixture includes up to about 20% of boron oxide.

27. The method of claim 21, wherein the melted mixture includes up to about 20% of gadolinium oxide.

28. The method of claim 21, wherein the melted mixture includes up to about 10% of boron oxide and about 10% of gadolinium oxide.

29. The method of claim 21, wherein the forming step produces amorphous basalt fibers.

30. The method of claim 21, wherein the radiation absorbing compounds include at least about 8% iron oxides.

31. The method of claim 21, wherein the melting chamber is heated to a temperature within the range of between about 1500° C. and about 2500° C.

32. The method of claim 31, wherein the mixture is melted within the melting chamber for between about 15 minutes to about 60 minutes.

33. The method of claim 32, further comprising:
stirring the mixture through an adjustment of induction frequency and power.

34. The method of claim 21, wherein the combining step includes chopping the basalt fibers into short fibers, so that the basalt fibers can be form a uniform distribution within the matrix material.

35. The method of claim 21, wherein radiation absorbing compounds have a predetermined composition to form basalt fibers having a composition of between about 45% and about 68% silicon dioxide, between about 14% and about 23% aluminum oxide, up to about 15% metal oxides, and up to about 30% of heavy metals having high neutron absorption cross sections selected from the group of Gadolinium and Boron.

36. A method for forming a radiation shielding composite material comprising:
mixing radiation absorbing compounds with basalt to form a mixture with the radiation absorbing compounds including between at least 5% and about 30% of heavy metals having high neutron absorption cross sections selected from the group of Gadolinium and Boron, Hafnium, Samarium, and Europium;
melting the mixture in a melting chamber through induction heating to produce a melted mixture;
forming the melted mixture into basalt fibers;
finishing the basalt fibers; and
combining the basalt fibers with a matrix material to form radiation shielding material.

37. The method of claim 36, wherein the radiation absorbing compounds include at least about 8% iron oxides.

38. The method of claim 37, wherein the melting chamber is heated to a temperature within the range of between about 1500° C. and about 2500° C.

39. The method of claim 38, wherein the mixture is melted within the melting chamber for between about 15 minutes to about 60 minutes.

40. The method of claim 39, further comprising:
stirring the mixture through an adjustment of induction frequency and power.
